(19) United States
(12) Patent Application Publication
(10) Pub. No.: US 2026/0131528 A1
(43) Pub. Date: May 14, 2026

(54) APPARATUS AND METHOD FOR MATERIAL DISPENSING IN ADDITIVE MANUFACTURING

(71) Applicant: Supernova Industries Corp., Austin, TX (US)

(72) Inventors: Roger Antunez Francisco, Barcelona (ES); Marta Mico Martinez, Barcelona (ES); Boris Agea Blanco, Barcelona (ES); Oriol Bel Laveda, Barcelona (ES); Vladimir Shumovskiy, Barcelona (ES); Manuel Joao Martins Barroeta, Barcelona (ES); Eric Pallares Garcia, Barcelona (ES)

(21) Appl. No.: 19/383,064

(22) Filed: Nov. 7, 2025

Related U.S. Application Data
(60) Provisional application No. 63/718,419, filed on Nov. 8, 2024.

(51) Int. Cl. B29C 64/147; B29C 64/218; B29C 64/245; B33Y 10/00; B33Y 30/00

(52) U.S. Cl. CPC B29C 64/147; B29C 64/218; B29C 64/245; B33Y 10/00; B33Y 30/00

(57) ABSTRACT

An additive manufacturing machine and a method for additive manufacturing. The additive manufacturing machine includes a drum defining a chamber and a pump including a pump inlet and a pump outlet, wherein the pump inlet is connected to the chamber. The additive manufacturing machine also includes a first fluid passageway connected to the pump outlet, a dispensing head including a dispensing end and a reservoir end, the reservoir end connected to the first fluid passageway. The additive manufacturing machine further includes a transfer film configured to move relative to the dispensing head, and a rotatable lamination roll mounted movably slidable relative to the transfer film between a first position and a second position, wherein when in the first position, the rotatable lamination roll is positioned under the dispensing end of the dispensing head.

### FIELD

The present disclosure relates to a system and method for material dispensing in additive manufacturing.

### BACKGROUND

Additive manufacturing is a process of forming parts by depositing one or more materials layer by layer, “building up” a component. The process generally utilizes digital computer models, such as a computer-aided designs or digital 3D models, sliced into layers, to control the selective deposition, melting, curing, and/or binding of material. Additive manufacturing accommodates complex geometries without the need for molds or dies. There are a number of additive manufacturing techniques that can be used for the formation of parts from liquid resin materials. For example, stereolithography (SLA) printing uses laser light to cure liquid resin stored in a vat by tracing the layer geometry with the laser. Digital light processing (DLP) uses light projected onto a vat to cure an entire layer of liquid resin all at once.

However, the processes noted above use resin precursors, exhibiting viscosities of less than 10,000 centipoise at room temperature (20 degrees Celsius). In processes for these materials, the resin precursors are generally gravity fed or use pumps to feed material into a printing vat or deposit material. These resins may lead to poor mechanical properties due to the composition of the precursors. As a result, the parts obtained are not always suitable for end-use and industrial applications. These applications include but are not limited to seals, structural brackets, automotive components such as under-the-hood parts and electrical connectors, footwear components including outer soles and orthoses, healthcare applications such as hearing aid components and medical devices, and battery components.

There are many challenges in manufacturing components formed from relatively high viscosity precursors, including material processibility due to the higher viscosity, the formation of voids, and poor layering. While extrusion and casting have been used in forming viscous polymers, geometries formed using these methods are limited. In addition, extrusion dies and molds are usually necessary for forming these materials.

Accordingly, room remains for improvement of additive manufacturing systems and methods for improved manufacturing resins having viscosities of 20,000 centipoise or greater.

### SUMMARY

According to various aspects, the present disclosure relates to an additive manufacturing machine. The additive manufacturing machine includes a drum defining a chamber and a pump including a pump inlet and a pump outlet, wherein the pump inlet is connected to the chamber. The additive manufacturing machine also includes a first fluid passageway connected to the pump outlet, a dispensing head including a dispensing end and a reservoir end, the reservoir end connected to the first fluid passageway. The additive manufacturing machine further includes a transfer film configured to move relative to the dispensing head, and a rotatable lamination roll mounted movably slidable relative to the transfer film between a first position and a second position, wherein when in the first position, the rotatable lamination roll is positioned under the dispensing end of the dispensing head.

In embodiments of the above, the drum includes an agitation element inserted in the chamber. In further embodiments, the agitation element includes one or more of the following: a mechanical agitator, an ultrasonic transducer, a magnetic stirrer, a pneumatic shaker, a pneumatic pump, a hydraulic shaker, a hydraulic pump, a shear plate, and a rotary tumbler.

In any of the above embodiments, the drum includes a heating element inserted in the chamber. In further embodiments, the drum further includes a temperature sensor inserted in the chamber. In yet further embodiments, the additive manufacturing machine includes a controller configured to execute code to control a temperature of a polymer precursor in the chamber based on one or more of the following: 1) a temperature measured by the temperature sensor, and 2) a viscosity measured by a power applied to the agitation element to maintain a given output velocity.

In any of the above embodiments, the additive manufacturing machine includes a pressure sensor operatively coupled to the first fluid passageway.

In any of the above embodiments, the additive manufacturing machine includes the pump includes at least one of a positive displacement pump, a piston pump, and a screw pump. In further embodiments, the dispensing head includes a first plate, a second plate defining a reservoir, and a shim positioned between the first plate and second plate, wherein the shim defines a cavity between the first plate and the second plate and the shim seals the cavity, and the first plate, the second plate and the shim define the dispensing end.

In any of the above embodiments, the dispensing head includes a temperature sensor. In further embodiments, the dispensing head includes a heating element.

In any of the above embodiments, the additive manufacturing machine further includes a build platform, the transfer film movably mounted on the build platform, the transfer film defining an external surface and an internal surface, and an idle roller rotatably mounted to the build platform and rotatably contacting the internal surface of the transfer film.

According to various additional aspects, the present disclosure relates to an additive manufacturing machine. The additive manufacturing machine includes a build platform and a transfer film movably mounted on the build platform, the transfer film defining an external surface and an internal surface. The additive manufacturing machine further includes a first bracket and a second bracket mounted to the build platform, a squeegee mounted to the first bracket and second bracket proximal to the external surface of the transfer film, and a pusher bar movably mounted to the first bracket and the second bracket, wherein in a first position the pusher bar does not contact the transfer film and in a second position the pusher bar slidably contacting the internal surface of the transfer film and pushes the transfer film against the squeegee.

In embodiments of the above the additive manufacturing machine further includes an eccentric roller mounted to the first bracket and the second bracket, wherein the eccentric roller contacts the pusher bar and rotation of the eccentric roller moves the pusher bar into the second position.

In any of the above embodiments, the additive manufacturing machine further includes a spring biasing the pusher bar in the first position.

In any of the above embodiments, the additive manufacturing machine further includes a catch basin mounted to the build platform under the squeegee and a fluid passageway connecting the catch basin to a drum. In further embodiments, the additive manufacturing machine further includes a filter mounted in the catch basin, wherein the filter is mounted under the squeegee.

According to various further aspects, the present disclosure relates to a method for additive manufacturing. The method includes preconditioning a polymer precursor in a preconditioning system, the preconditioning system including a drum defining a chamber, a heating element inserted in the chamber, a temperature sensor inserted in the chamber, and an agitation element inserted in the chamber. The method further includes transferring the polymer precursor from the preconditioning system to a dispensing head, dispensing the polymer precursor from the dispensing head, and transferring the polymer precursor from the dispensing head onto a transfer film with a lamination roller at a first angular speed. The method also includes moving the transfer film at a first linear velocity while transferring the polymer precursor from the dispensing head, moving the polymer precursor on the transfer film under a light engine, raising a print bed towards the transfer film, and contacting the polymer precursor with at least one of a support surface and a previously printed layer if present. The method also includes emitting light onto the polymer precursor to at least partially cure the polymer precursor, transferring the at least partially cured polymer precursor onto the at least one of the support surface and the previously printed layer, and removing an excess polymer precursor from the transfer film.

In embodiments of the above, wherein removing the excess polymer precursor from the transfer film includes contacting the transfer film with a squeegee by forcing the transfer film against the squeegee with a pusher bar. In further embodiments, the method includes collecting the excess polymer precursor in a catch basin located under the squeegee; filtering the excess polymer precursor; and returning the excess polymer precursor to the drum.

According to various aspects, the present disclosure also relates to a preconditioning system for an additive manufacturing machine. The preconditioning system includes a drum defining a chamber, a heating element inserted in the chamber, a temperature sensor inserted in the chamber, and an agitation element inserted in the chamber.

In embodiments of the above, the agitation element includes one or more of the following: a mechanical agitator, an ultrasonic transducer, a magnetic stirrer, a pneumatic shaker, a pneumatic pump, a hydraulic shaker, a hydraulic pump, a shear plate, and a rotary tumbler.

In further embodiments, the preconditioning system further includes a controller configured to execute code to control a temperature of a resin precursor in the chamber based on one or more of the following: 1) the temperature measured by the temperature sensor, and 2) the viscosity measured by the power applied to the agitation element to maintain a given output velocity.

In any of the above embodiments, the preconditioning system further includes a pump including an inlet and an outlet, the inlet connected to the chamber. In further embodiments, the pump includes at least one of a positive displacement pump, a piston pump, and a screw pump.

### BRIEF DESCRIPTION OF THE DRAWINGS

The drawings described herein are for illustration purposes only and are not intended to limit the scope of the present disclosure in any way.

FIG. 1 illustrates a front view of an additive manufacturing machine according to embodiments of the present disclosure.

FIG. 2 illustrates a print bed, support surface, and light engine according to embodiments of the present disclosure.

FIG. 3 illustrates the transfer film management system, according to embodiments of the present disclosure.

FIG. 4 illustrates pusher system, according to embodiments of the present disclosure.

FIG. 5 illustrates a material feed system, according to embodiments of the present disclosure.

FIG. 6 illustrates a cross-sectional view of the drum, according to embodiments of the present disclosure.

FIG. 7A illustrates a rear view of a material dispensing head, according to embodiments of the present disclosure.

FIG. 7B illustrates a rear view of a material dispensing head, according to embodiments of the present disclosure.

FIG. 8 illustrates a cross-sectional side view of a material dispensing head, according to embodiments of the present disclosure.

FIG. 9 illustrates an exploded, top-perspective view of a dispensing head, according to embodiments of the present disclosure.

FIG. 10 illustrates an exploded, bottom-perspective view of the dispensing head of FIG. 9, according to embodiments of the present disclosure.

FIG. 11A illustrates a close-up of the material feed system in a first position, a pusher system, and a squeegee, according to embodiments of the present disclosure.

FIG. 11B illustrates a close-up of the material feed system in a second position, a pusher system, and a squeegee, according to embodiments of the present disclosure.

FIG. 12 illustrates a cross-sectional, rear perspective view of the dispensing head, squeegee, filter, and catch basin, according to embodiments of the present disclosure.

FIG. 13 illustrates a method of dispensing a polymer precursor and printing a polymer precursor, according to embodiments of the present disclosure.

FIG. 14 illustrates a system according to embodiments of the present disclosure.

FIG. 15 illustrates a method of calibrating the lamination roll according to embodiments of the present disclosure.

### DETAILED DESCRIPTION

The following description is merely exemplary in nature and is not intended to limit the present disclosure, application, or uses. Furthermore, there is no intention to be bound by any expressed or implied theory presented in the preceding introduction, summary, or the following detailed description. It should be understood that throughout the drawings, corresponding reference numerals indicate like or corresponding parts and features.

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale.

The present disclosure relates to systems and methods for material dispensing in additive manufacturing, including a preconditioning system, a deposition system, and a material recovery system. The system and process may be used with photopolymer precursors that exhibit pre-cursor viscosities of 20,000 centipoise or greater, such as up to 5,000,000 centipoise. However, while the system and method are described for use with photopolymer precursors exhibiting a photopolymer pre-cursor viscosity of 20,000 centipoise or greater, the system and method may be used with photopolymer precursors exhibiting a pre-cursor viscosity of less than 20,000 centipoise. In addition, while the systems and methods described herein may be used to make seals, structural brackets, automotive components such as under-the-hood parts and electrical connectors, footwear components including outer soles and orthoses, healthcare applications such as hearing aid components and medical devices, and battery components, other printed components may be formed using the system and methods described herein.

The photopolymer polymer precursors exhibit a viscosity of 10,000 centipoise or greater, such as in the range of 1 centipoise to 5,000,000 centipoise, including all values and ranges therein such as in the range of 20,000 centipoise to 100,000 centipoise, 100,000 centipoise to 1,000,000 centipoise, etc. Light, exhibiting one or more wavelengths in the range of 250 nanometers to 750 nanometers, including all values and ranges therein, is used to polymerize the resin precursors. In embodiments, the precursors are cured using light exhibiting one or more wavelengths in the range of 320 nanometers to 435 nanometers, including all values and ranges therein. In embodiments, the polymer precursors include at least one of a monomer and an oligomer, at least one photoinitator, and, optionally, one or more fillers and additives.

The monomers and oligomers include, but are not limited to, one or more of the following: acrylate, methacrylate, vinyl, thiol, epoxy, oxetane, hydroxy, and hydride functional liquid silicones, liquid polyurethanes, urethane monomers, rubbers, and polybutadienes. In further embodiments, the monomers and oligomers include methacrylates and acrylates functional groups on linear, branched, star, or comb urethane, silicone, or polyolefin (polypropylene, polyethylene) backbones. The photoinitators, in embodiments, include at least one of a type I photoinitators such as hydroxyacetophenone (HAP) and phosphineoxide such as diphenyl(2,4,6-trimethylbenzoyl)phosphine oxide (TPO), ethyl (2,4,6-trimethylbenzoyl) phenylphosphinate (TPO-L), phenylbis(2,4,6-trimethylbenzoyl)phosphine oxide (BAPO)), and a type II photoinitiator such as Benzophenone and benzophenone-type photoinitiators, which also require the use of a co-initiator such as an alcohol, amine, thiol or otherwise. The photoinitators (and co-initiators, if present) are present in the range of 0.01 percent by weight to 5 percent by weight, including all values and ranges therein.

The fillers include, but are not limited to one or more of the following: ceramics including silica, alumina, zirconia, ferrites, barium titanate, silicon carbide, silicon nitride, boron carbide, hydroxyapatite, aluminum trihydrate, zinc oxide, and combinations thereof; metals including but not limited to one or more transition metals, which are understood as metals that include valence electrons in two shells instead of only one; and metal alloys, which are understood to include one or more metals or one or more metals with one or more non-metallic elements. Other additives may be added including plasticizers such as dioctyl adipate, diisooctyl phthalate; and additional fillers such as silica in non-ceramic based formulations, glass, and organic materials such as rosin, amine, amide, poly amide, polyurethane, urethane, melamine, phosphinate etc. The fillers are inclusive of all morphology including but not limited to spheres, fibers, flakes, tubes, milled, ground, natural, and cubes. The fillers may be present in the range of 0.1 percent by weight to 90 percent by weight of the total weight of the polymer precursor, including all values and ranges therein such as 0.1 percent by weight to 10 percent by weight, 10 percent by weight to 25 percent by weight, etc. The polymer precursors including fillers may exhibit a viscosity in the range of 20,000 to 5,000,000 centipoise at room temperature (23 degrees Celsius), including all values and ranges therein.

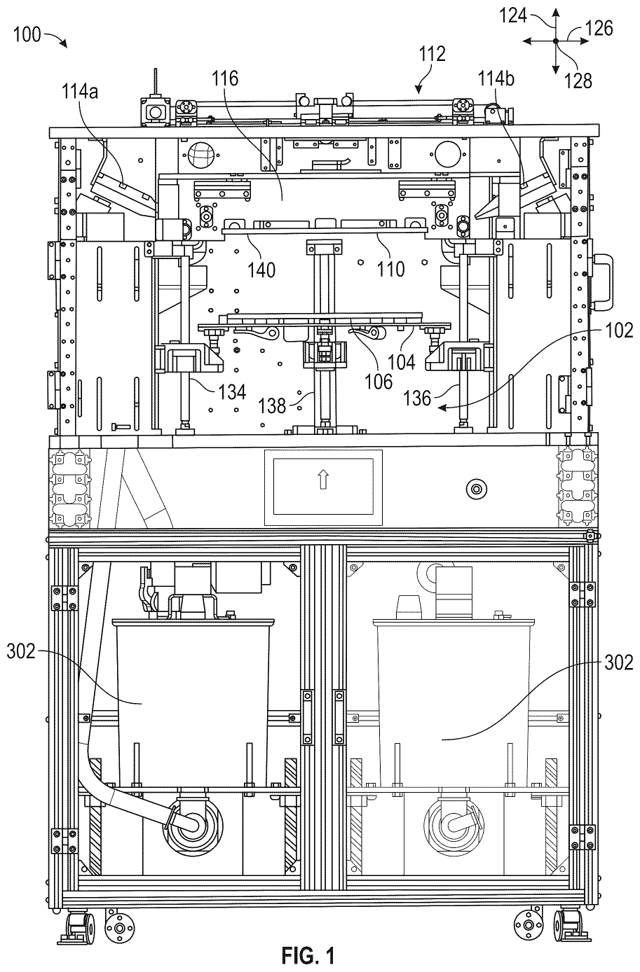

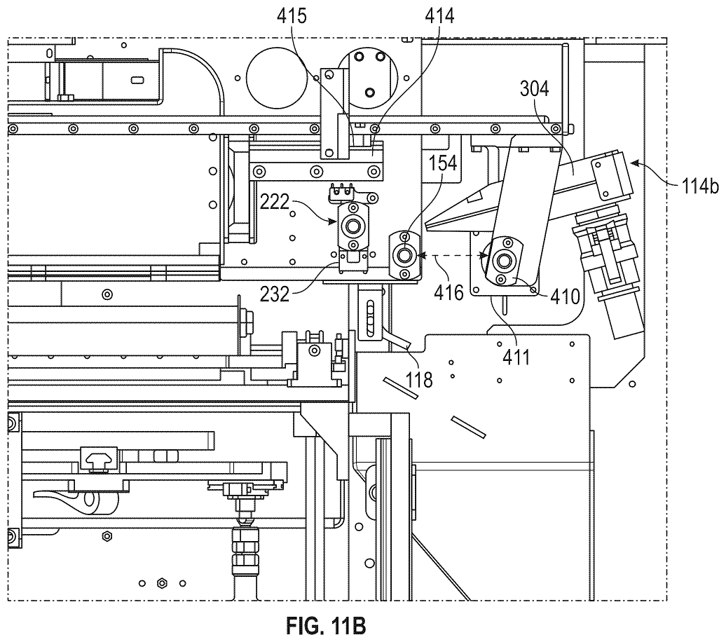

FIG. 1 illustrates an additive manufacturing machine 100 for forming components using, but not limited to, the polymer precursors described above. The additive manufacturing machine 100 includes a build platform 101 that defines a process chamber 102. In some embodiments, the temperature and the humidity are controlled within the process chamber 102. Within the process chamber 102 is a print bed 104 including a support surface 106 on which a component is printed. The additive manufacturing machine 100 further includes a transfer film 110 and a transfer film management system 112 mounted on the build platform 101 for moving the transfer film 110 back and forth between one or more material feed systems 114a, 114b and a light engine 116 over the print bed 104. The transfer film 110 defines an internal surface 121 (see FIG. 11A) and an external surface 122. The transfer film 110 is selected based on physiochemical properties between the transfer film 110 and the polymer precursor that define the peeling force per unit area to release an at least partially cured layer of polymer precursor from the transfer film 110. Further, the transfer film 110 must be optically transparent to the light emitted from the light engine 116. In embodiments, the transfer film 110 is a composite formed from one or more layers of film or includes one or more layers of a film with a coating that alters the surface energy or other surface characteristics of the transfer film 110. In yet further embodiments, the transfer film 110 may include a desired surface roughness, or exhibit features formed in the surface of the film to improve transfer of the polymer precursor from the transfer film 110 onto the component.

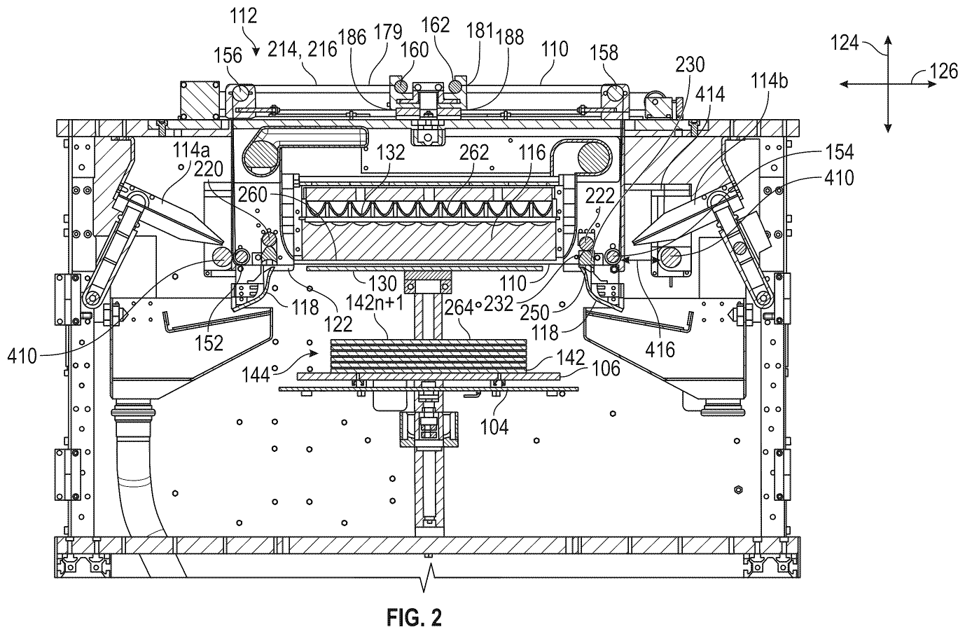

In operation, as illustrated in FIG. 2, a layer 130 of the polymer precursor is dispensed by the material feed system 114a, 114b onto the transfer film 110, and specifically to the external surface 122 of the transfer film 110 facing the support surface 106 of the print bed 104 as the transfer film 110 is moved from the material feed system 114a, 114b to the light engine 116. The layer 130 of the polymer precursor is positioned over the support surface 106 of the print bed 104 and under the light engine 116. The support surface 106 is then raised in a first axis 124, the “z-direction”, toward the transfer film 110 and contacts the polymer precursor layer 130. The light source 132 in the light engine 116 is activated and light is emitted and projected through the transfer film 110 onto the polymer precursor at a sufficient dosage and in specific locations to at least partially cure or solidify the polymer precursor to form the next component layer. If previous layers of the component are present, the polymer precursor may also bind to the previously printed layers. The at least partially cured polymer precursor is transferred to the support surface 106 of the print bed 104 and the print bed 104 is lowered in the first axis 124. After the at least partially cured polymer precursor is deposited onto the print bed 104 by transferring the at least partially cured layer on the print bed 104, excess photopolymer precursor on the transfer film 110 is removed from the transfer film 110 by one or more squeegees 118 and the process is repeated. In embodiments, the squeegees 118 are mounted to the first side bracket 170 and second side bracket 172. Further, in embodiments, the squeegees 118 are mounted in at least one of a rotatable manner around a pivot point or a movable manner sliding up and down relative to the transfer film.

Referring again to FIG. 1, the print bed 104 is coupled to at least three linear actuators 134, 136, 138 for moving the print bed 104 up and down in the first axis 124, i.e., the z-direction. In alternative embodiments, one, two, four or more linear actuators may be provided. The linear actuators 134, 136, 138 may each include, for example, a threaded spindle and ball screw drive, roller screw drive, linear motor, etc. The print bed 104 is connected to the linear actuators 134, 136, 138 using ball joints allowing the print bed 104 to move in an angular direction. Movement of the linear actuators 134, 136, 138 at the same rate allows for the print bed 104 to maintain parallelism with the base 140 of the light engine 116 as it is raised and lowered along the z-axis 124.

Each linear actuator 134, 136, 138 may also be separately adjusted so that the print bed 104 may be angled at various angles from the plane defined by a second axis 126 and a third axis 128 orthogonal to both the first axis 124 and the second axis 126 up to 20 degrees in any given direction. Angling the print bed 104 while raising the support surface 106 up to the transfer film 110 may assist in reducing void formation between the at least partially cured polymer precursor being transferred and the previously transferred layer 142n+1 or the support surface 106, itself. Angling of the print bed 104 and support surface 106 may also be used to assist in peeling the at least partially cured polymer precursor being transferred from the transfer film 110.

Supported on the print bed 104 is a support surface 106 on which the various layers 142, 142 n+1 of the component 144 are transferred (see FIG. 2). The support surface 106 is, in embodiments, removably mounted onto the print bed 104 to facilitate removal of printed components from the print bed 104 as well as to allow for the use of different support surface 106 materials based on the polymer precursor. In addition, while the support surface 106 is illustrated as being relatively flat and rectangular, the support surface 106 may exhibit other geometries and have a relatively circular or oblong surface or exhibit a relatively curvate shape in the z-axis. Further, the support surface 106 may exhibit various surface finishes and textures to prevent slippage of the component during printing, facilitate release of the printed component, or both prevent slippage of the component during printing and facilitate release of the printed component. Additionally, the support surface 106 may exhibit various coatings to prevent slippage of the component during printing, facilitate release of the printed component, or both prevent slippage of the component during printing and facilitate release of the printed component. In yet further embodiments, the support surface 106 may include a flexible release surface on which the component 144 is printed. The flexible release surface may be held onto the support surface by one or more of mechanical and magnetic means.

Either the print bed 104 or the support surface 106 may include additional sensors. Such sensors may include force sensors, such as load cells, piezoelectric sensors, or pressure sensors. These sensors may be used to detect the peeling forces during printing. The print bed 104 or support surface 106 may also include a temperature sensor for measuring the temperature of at least one of the print bed 104 and the support surface 106.

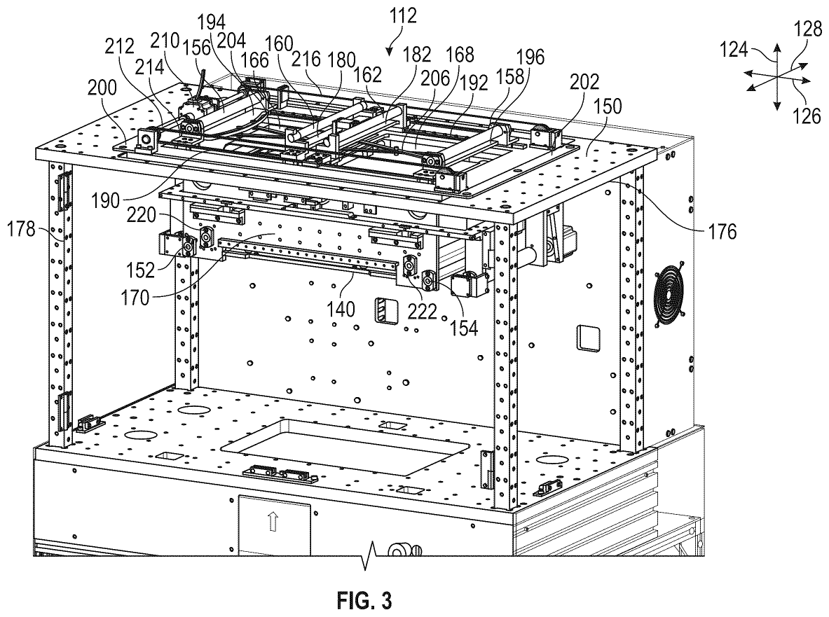

As noted above and referring again to FIGS. 2 and 3, the transfer film 110 is moved back and forth between the material feed system 114a, 114b, the light engine 116, and the squeegees 118 by a transfer film management system 112. The transfer film management system 112 includes a first platform 150, idle rollers 152, 154 (see FIG. 2), tension rollers 156, 158, and retention mounts 160, 162. Openings 166, 168 in the first platform 150 accommodate the movement of the transfer film 110 between the idle rollers 152, 154 and the tension rollers 156, 158.

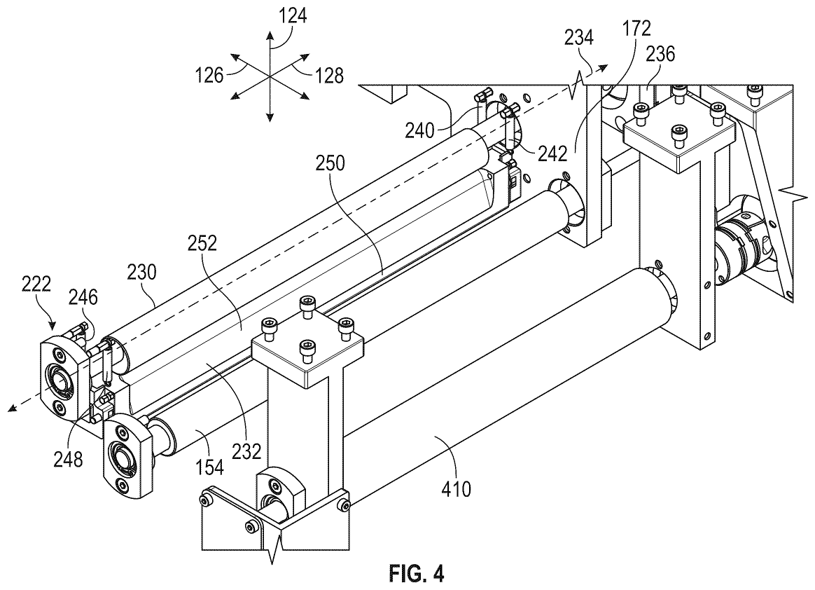

The idle rollers 152, 154 space the transfer film 110 from the base 140 of the light engine 116 in the first axis 124, so that the transfer film 110 touches and slides across the base 140 of the light engine 116 reducing the stress that may be incurred if the transfer film 110 passed over the corners of the light engine 116 on either side of the base 140. In some embodiments, the idle rollers 152, 154 rotate with the transfer film 110 as the transfer film 110 is shuttled back and forth relative to the material feed system 114a, 114b and the light engine 116. The idle rollers 152, 154 are supported at either end of each roller in a rotating manner by a first side bracket 170 and a second side bracket 172 illustrated in FIG. 4. The first side bracket 170 and the second side bracket 172 are connected to and extend from the base 176 of the first platform 150. Alternatively, the first side bracket 170 and second side bracket 172 may be connected to and extend from the frame 178 of the additive manufacturing machine 100. The transfer film 110 is also supported by the tension rollers 156, 158, which in some embodiments may rotate with the transfer film 110 as it passes over the tension rollers 156, 158.

The transfer film 110 is secured at each end 179, 181 (see FIG. 2) to retention mounts 160, 162, which in the illustrated embodiment are rollers. The first retention mount 160 is secured on a first carriage 186 and the second retention mount 162 is secured to a second carriage 188. The first carriage 180 and the second carriage 182 span the first platform 150 in the third axis 128. The first carriage 180 and the second carriage 182 are movably connected to rails 190, 192 at either end of the carriages 180, 182. The first rail 190 and second rail 192 are parallel.

The first tension roller 156 is supported by a third carriage 194 and the second tension roller 158 is supported by a fourth carriage 196 that each span the first platform 150. The tension rollers 156, 158 are located proximally to the ends 200, 202 of the first platform 150 and the retention mounts 160, 162 are located inward of the tension rollers 156, 158. The third carriage 194 and fourth carriage 196 are slidably connected to the rails 190, 192 and move back and forth on the rails 190, 192 along the second axis 126. The tension rollers 156, 158 are each spaced from the retention mounts 160, 162 by a pair of adjustable brackets 204, 206.

In operation, the transfer film 110 is secured at a first end to the first retention mount 160, is wrapped around the first tension roller 156, through the first opening 166, around the first idle roller 152, adjacent to the base 140 of the light engine 116, around the second idle roller 154, up through the second opening 168, around the second tension roller 158 and is secured to the second retention mount 162. In this manner, the transfer film exhibits a trapezoidal, or “C” shape. A motor 210 is coupled to a shaft 212, which drives the second carriage 182 back and forth by a set of pulleys 214, 216.

In alternative embodiments, the ends 179, 181 of the transfer film 110 are not connected to the retention mounts 160, 162 but are connected together and the transfer film 110 rotates completely around, rather being shuttled back and forth. In such an embodiment, the pulleys 214, 216 are coupled to at least one of the tension rollers 156, 158 or at least one of the retention mounts 160, 162 to drive the roller(s). In further embodiments, one or more of the driven rollers, i.e., the tension rollers 156, 158 or the retention mounts 160, 162, include a sprocket or other device that engages with the transfer film 110 and rotates the transfer film 110 in complete circles.

The transfer film management system 112 also includes at least one pusher system 220, 222 for pushing on the transfer film 110 to apply tension on the transfer film 110, to angle the transfer film 110 at a desired angle, or to push the transfer film 110 towards the squeegees 118 and to contact the squeegees 118 to remove excess, uncured photopolymer precursor. As may be appreciated, more than one, such as two pusher systems 220, 222 as illustrated, to four pusher systems, or even more pusher systems, may be present. FIG. 4 illustrates pusher system 222 and the description herein regarding pusher system 222 is equally applicable to pusher system 220, which pushes the transfer film 110 away from the base 140 of the light engine 116 facilitating the peeling of the at least partially cured polymer precursor from the transfer film 110. The pusher system 220, 222 may also cause the transfer film 110 to contact the squeegees 118 to remove excess polymer precursor off the transfer film 110 as the transfer film 110 retreats or moves to a second material feed system 114b after transferring the at least partially cured polymer precursor. The pusher systems 220, 222 may also be used to tilt the transfer film 110 relative to the support surface 106 as the support surface 106 is being raised upward to receive a new layer of polymer precursor to allow air to flow away from the interface of the already transferred layers 142, 142n+1 and the new layer to avoid voids.

The pusher systems 220, 222 are secured at each side by the first side bracket 170 and second side bracket 172. As illustrated, the pusher systems 220, 222 are mounted internally of, proximal to, and generally parallel to, the first and second idle rollers 152, 154, and traverse to the movement of the transfer film 110 so that the transfer film 110 passes under the pusher system 220, 222. The pusher system 220, 222 generally includes an eccentric roller 230 rotatably mounted in the first side bracket 170 and the second side bracket 172 and a pusher bar 232 mounted to the first side bracket 170 and second side bracket in a slidable manner, wherein the pusher bar 232 slides up and down in the first axis 124 relative to the rotating axis 234 of the eccentric roller 230. The rotating axis 234 of the eccentric roller 230 is generally parallel to the third axis 128. Alternatively to using eccentric rollers 230, pneumatic or hydraulic actuators may be used to apply force against the pusher bar 232 or directly against the film.

In operation the pusher bar 232 is pushed down by rotating the eccentric roller 230, or alternative actuator, using a motor 236 attached to the eccentric roller 230 until the apogee of the eccentric roller 230 is contacting the pusher bar 232. At this point, the distance between the surface of the pusher bar 232 contacting the eccentric roller 230 and the rotating axis 234 is at a maximum. One or more springs 240, 242, 244, 246 pull or push (or biasing) the pusher bar 232 back up as the eccentric roller 230 continues to rotate and reaches the perigee of the eccentric roller 230. At this point, the distance between the pusher bar 232 contacting the eccentric roller 230 and the rotating axis 234 is at a minimum. Referring to FIG. 2, the pusher bar 232 exhibits a curvate geometry at the base 250 of the pusher bar 232 and defines a generally concave surface. In embodiments, the exterior corners of the base 250 are rounded, reducing stresses applied to the transfer film 110. Further, the top 252 of the pusher bar 232 is rounded forming a convex surface. This reducing the overall weight of the pusher bar 232.

With reference again to FIG. 2, the light engine 116 includes a light source 132. The light source 132 is spaced away from a transparent plate 260, such as a glass plate of a liquid crystal display, through which light emitted from the light source 132 passes. The transparent plate 260 also serves as a support for the transfer film 110, particularly as the print bed 104 is elevated to contact a polymer precursor layer 130. The light source 132 may include, but is not limited to, for example light emitting diodes, a liquid crystal display, and mercury lamps. The light source 132 may include an array of individual light sources 132 is illustrated. Further, in embodiments, a light emitting diode array including one or more elements 262 including at least one of optical elements or refractive elements providing at least one of collimation, a pixilated display, a projector, or a physical mask may be used to make the desired shapes and patterns for each cross section. The light source 132 may exhibit a power density as measured at the surface 264 of the previously transferred layer 142n+1 of 3 milliwatts per centimeter squared to 1000 milliWatts per centimeter squared, including all values and ranges therein, such as 4 milliwatts per centimeter squared to 10 milliWatts per centimeter squared, 100 milliWatts per centimeter squared to 500 milliWatts per centimeter squared. As noted above, the light emitted from the light source 300 exhibits one or more wavelengths in the range of 250 nanometers to 750 nanometers, including all values and ranges therein, such as one or more wavelengths in the range of 250 nanometers to 435 nanometers.

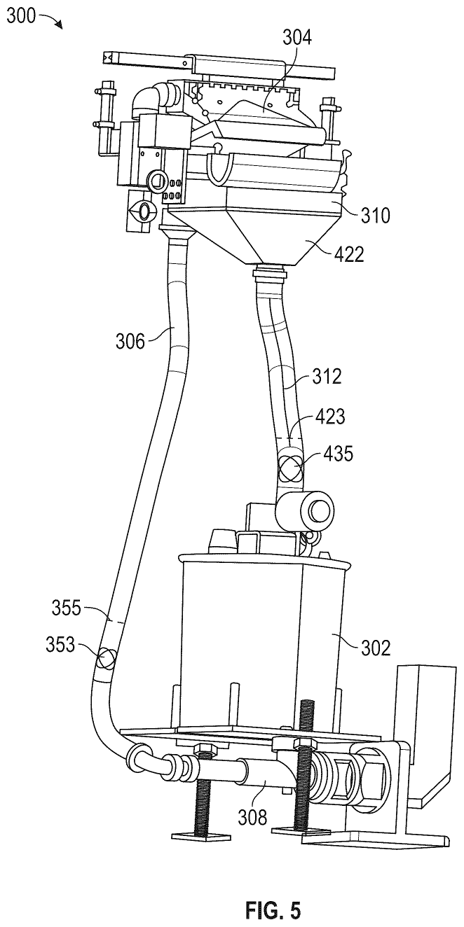

FIG. 5 illustrates material feed system 114a, 114b (referred to herein as 114). The material feed system 114 generally includes a drum 302, a dispensing head 304, a first fluid passageway 306 for transferring the polymer precursor from the drum 302 to the dispensing head 304, a pump 308 for transferring the polymer precursor from the drum 302 into the first fluid passageway 306, a capture system 310 for receiving excess polymer precursor, and a second fluid passageway 312 for returning excess polymer precursor into the drum 302. One or more material feed systems 114a, 114b may be provided, such as the two illustrated. One material feed system 114a may include a first polymer precursor and the second material feed system 114b may include the same or a different, second polymer precursor. Where more than one material feed system 114 is present, the transfer film 110 may shuttle between the material feed systems 114a, 114b as needed during printing.

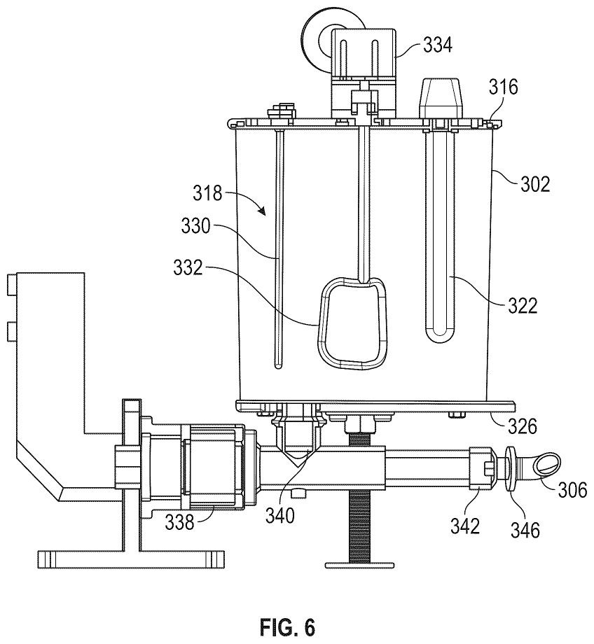

FIG. 6 illustrates a cross-sectional view of the drum 302. The drum 302 includes a lid 316 and defines a chamber 318 therein. A heating element 322 is operatively connected to the drum 302 such that the heating element 322 directly or indirectly heats the contents, i.e., the polymer precursor, in the drum 302. In embodiments, the heating element 322 is inserted into the drum 302 through the lid 316 as illustrated. Alternatively, the heating element 322 may be inserted into a side wall 324 or the bottom 326 of the drum 302. In additional or alternative embodiments, the heating element 322 may surround the side wall 324 or base 326 of the drum 302. The heating element 322 may be resistive, radiative, or inductive. A temperature sensor 330 is also operatively coupled to the drum 302 such that the temperature sensor 330 directly or indirectly measured the temperature of the polymer precursor in the drum 302. In embodiments, the temperature sensor 330 is inserted into the drum 302 through the lid 316 as illustrated. Alternatively, the temperature sensor 330 may be inserted into a side wall 324 or the bottom 326 of the drum 302. In additional or alternative embodiments, the temperature sensor 330 is connected to a side wall 324 or base 326 of the drum 302. Data obtained from the temperature sensor 330 is used to control the heating element 322 and to regulate the temperature of the polymer precursor in the drum 302. In embodiments, the temperature is controlled using a closed loop process. The viscosity of the polymer precursor and, in turn, lamination behavior is understood to be dependent upon the temperature of the polymer precursor.

The drum 302 further includes an agitation element 332 used to agitate the polymer precursor in the drum 302. The agitation element 332 is operatively coupled to the drum 302 such that the agitation element 332 directly or indirectly agitates the polymer precursor in the drum 302. In embodiments, the agitation element 332 is inserted into the drum 302 through the lid 316 as illustrated. Alternatively, the agitation element 332 may be inserted into a side wall 324 or the bottom 326 of the drum 302. In additional or alternative embodiments, the agitation element 332 is connected to a side wall 324 or base 326 of the drum 302. The agitation element 332 includes, in embodiments, a mechanical agitator as illustrated. Mechanical agitators include at least one of a paddle, mixing head, a helical screw, rotary elements, and reciprocating element. Alternatively, or additionally, the agitation element 332 includes at least one of an ultrasonic transducer, a magnetic stirrer, a pneumatic shaker, a pneumatic pump, a hydraulic shaker, a hydraulic pump, a shear plate, or a rotary tumbler. While a single agitation element 332 is illustrated, more than one agitation element 332 may be provided, such as in the range of two to six agitation elements. The agitation element 332 is driven by an agitation motor 334. The use of the agitation element 332 assists in maintaining a homogenous temperature throughout the polymer precursor in the drum 302 and applies shear forces to the polymer precursor to adjust the dynamic viscosity of the polymer precursor. As some of the polymer precursors may exhibit a non-Newtonian behavior (shear-thinning or thixotropic), agitation may apply shear in order to adjust the dynamic viscosity of the polymer precursor within a target range. Agitation also helps to disperse the fillers and other additives that may be present in the polymer precursor. Further, the power applied to the agitation motor 334 to achieve a given output velocity may be used to monitor the viscosity of the polymer precursor.

In embodiments, a pump 308 is used to transport polymer precursor from the drum 302 to the dispensing head 304. The pump 308 includes an inlet 340 and an outlet 342. As illustrated, the inlet 340 of the pump 308 is connected to the bottom 326 of the drum 302 and the outlet of the pump 308 is connected to the inlet 346 of the first fluid passageway 306. The pump 308 includes at least one of a positive displacement pump, a piston pump, and a screw pump. The positive displacement pump may include a gear pump, a lobe pump, or a progressive cavity pump. The pump 308 provides the material through the first fluid passageway 306 to the dispensing head 304 at a desired flow rate.

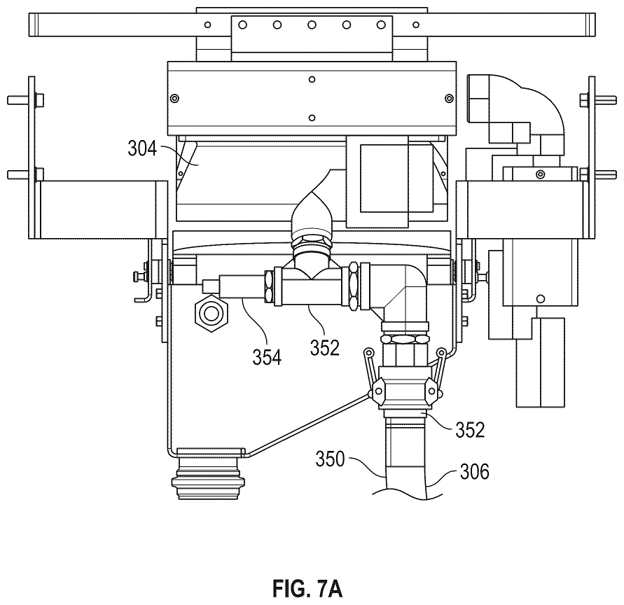

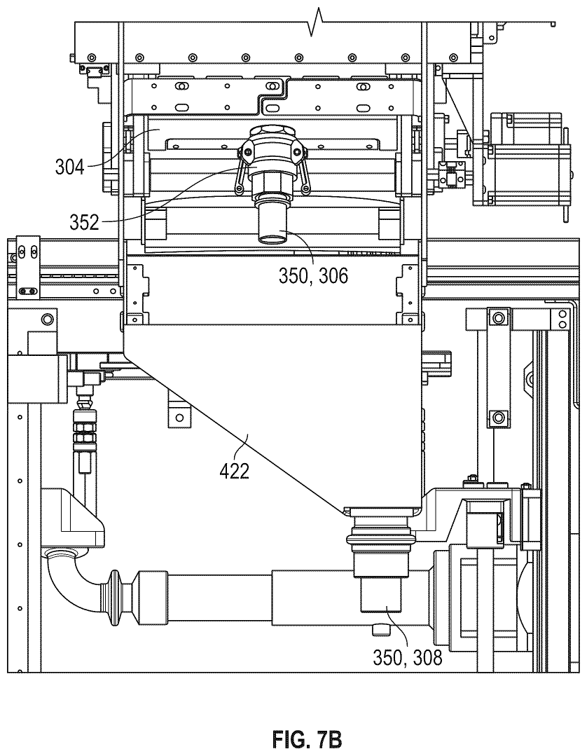

As illustrated in FIGS. 5, 7A, and 7B, the first fluid passageway 306 includes, e.g., pipes 350 and couplings 352. As may be appreciated, various arrangements of pipes 350 and coupling 352 may be used. FIG. 7A and FIG. 7B illustrate different arrangements of pipes 350 and coupling 352 used to form the first fluid passageway 306. The pipes may be flexible tubes or rigid. In embodiments, the first fluid passageway 306 includes one or more ball valves for closing off segments of the first fluid passageway 306. One or more pressure sensor 354 (see FIG. 7A) may be provided to measure at least one of the static pressure and dynamic pressure in the first fluid passageway 306. In embodiments, the pressure sensor 354 is used to prevent over-pressuring the system, turning off the pump 308 to stop feeding the polymer precursor into the first fluid passageway 306 or reducing the flow rate from the pump 308. In embodiments, the pressures sensor 354 are included in-line. Alternatively or additionally, the pressure sensors 354 are included in, or operatively coupled to, valves to open or close the valve and stop or allow for movement of the polymer precursor through the first fluid passageway 306. Further, with reference to FIG. 5, one or more mixing element 353 may be provided in the first fluid passageway 306 to generate shear in the polymer precursor. In addition, one or more filters 355 may be included in the first passageway 306, which may also be used to induce shear in the polymer precursor.

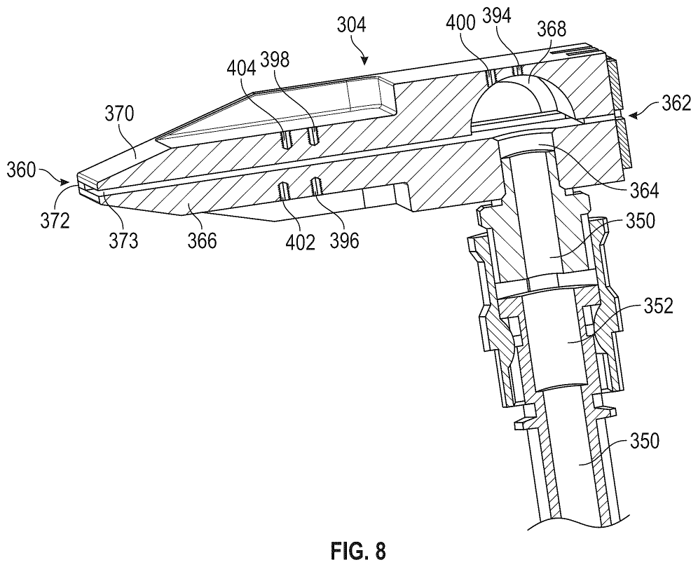

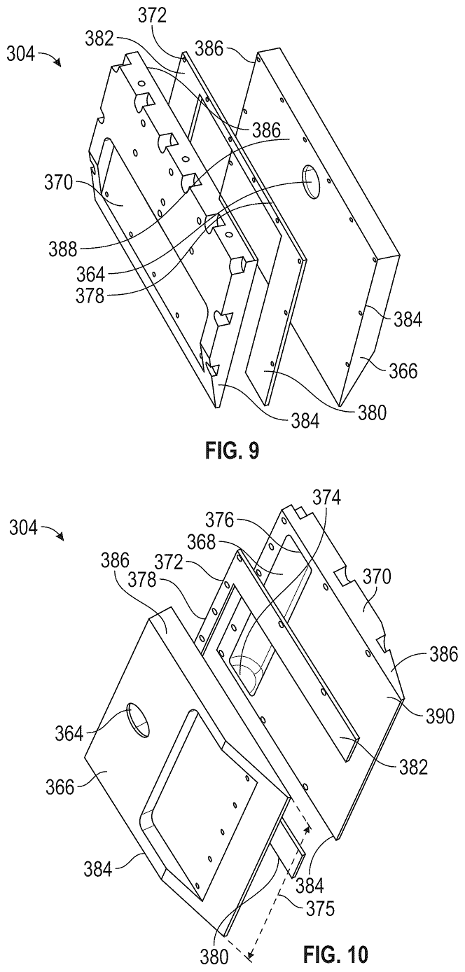

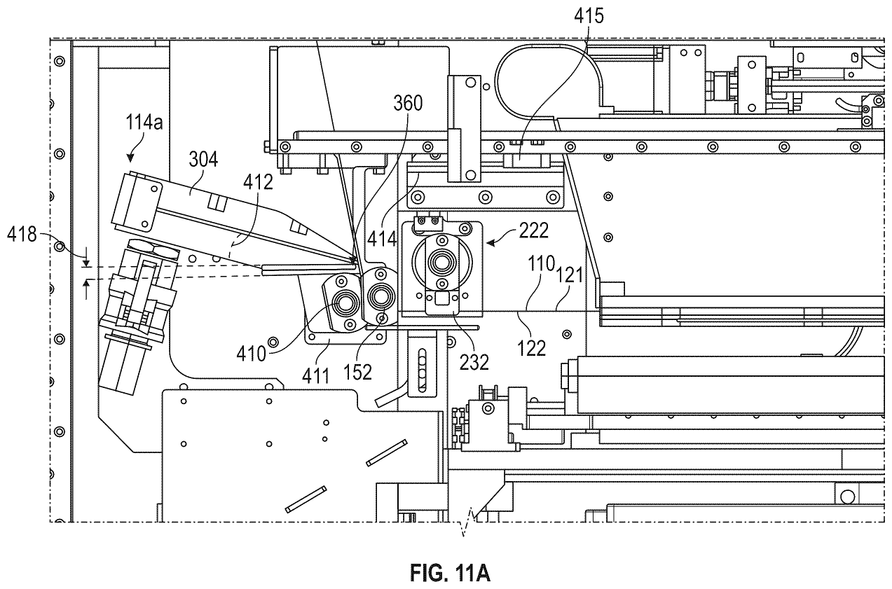

As illustrated in FIGS. 8, 9, and 10, the dispensing head 304 is coupled to the first fluid passageway 306. The dispensing head 304 includes a dispensing end 360 and a reservoir end 362. The first fluid passageway 306 is connected to the polymer precursor to the reservoir end 362. As illustrated in FIGS. 9 and 10, the first fluid passageway 306 is coupled to a channel 364 defined in a first plate 366, which is fluidly connected to a reservoir 368 defined in a second plate 370. The polymer precursor flows from the first fluid passageway 306 through the first plate 366 and into the reservoir 368 defined in the second plate. In the reservoir 368, the polymer precursor is spread across the second plate 370 to each end 374, 376 of the reservoir 368. The volume defined by the reservoir 368 may be sufficient for multiple lamination layers 130. The geometry of the reservoir 368 may be adjusted to alter the flow of the polymer precursor, depending on the rheology profile and dynamic viscosity of the polymer precursor.

In addition, the first plate 366 and second plate 370 are separated by a shim 372 creating a cavity 373 between the first plate 266 and the second plate 370. The separation of the first plate 366 and the second plate 370 by the shim 372 defines a cavity and seals the cavity allowing for the polymer precursor to flow between the first plate 366 and second plate 370 and out through the dispensing end 360. The dispensing end 360 is defined by the shim 372, the first plate 366 and the second plate 370. In the illustrated embodiment, the shim 372 includes three legs, a first leg 378, a second leg 380, and a third leg 382, wherein the legs 378, 380, 382 generally form a “U” shape. The first leg 378 seals the reservoir end 362, preventing the polymer precursor from flowing out of the reservoir end. The second leg 380 and third leg 382 seal the sides 384, 386 of the dispensing head 304. In embodiments, the shim 372 is exchangeable with shims having different thicknesses to adjust the distance between the interior surface 388, 390 of the first plate 366 and second plate 370. Further, in alternative embodiments, the geometry of the shim may be adjusted to exhibit a different configuration or variable thickness to alter the lamination patterns, create flow zones and alter the thickness between the interior surfaces 388, 390. In embodiments, the cavity 373 is shaped to expand the polymer precursor in width 375, up to 30 centimeters, across the lip 377 of the dispensing end 360 as the polymer precursor is being delivered to the lamination roll 410 (see FIG. 2) to provide a relatively uniform distribution of polymer precursor across the lamination roll 410.

In embodiments, the dispensing head 304 includes one or more heating elements and one or more temperature sensors. Referring to FIG. 8, in embodiments, a first heating element 394 is operatively coupled to the reservoir 368, a second heating element 396 is coupled to the first plate 366, and a third heating element 398 is coupled to the second plate 370. While, in embodiments, the first heating element 394 may be inserted into the flow path of the polymer precursor; however, this may interrupt the flow of the polymer precursor. In alternative embodiments, the first heating element 394 may be inserted into the second plate 370 proximal to the reservoir 368 and the third heating element 398 may be provided between the reservoir 368 and the dispending end 360 of the dispensing head 304. In embodiments, associated with each heating element 394, 396, 398 is a temperature sensor 400, 402, 404. Monitoring and regulation of the temperature in the dispensing head 304 assists in regulating the dynamic viscosity of the polymer precursor.

As alluded to above, the polymer precursor is delivered to a lamination roll 410 and associated with each material feed system 114a, 114b and the transfer film 110 by way of the dispensing head 304 as illustrated in FIG. 11 A and B. As alluded to above, the transfer film 110 moves relative to the dispensing head 304 and lamination roll 410 by way of the transfer film management system 112. The lamination roll 410 is rotatably driven by a motor 411. The amount of polymer precursor dispensed on the lamination roll 410 is regulated by turning the pump 308 on and off and adjusting the flow rate of the pump 308. The pump 308 may also be reversed to provide suction and withdraw the material from the dispensing head 304 if needed. Further, the dispensing head 304 may be angled relative to the lamination roll 410 a desired angle 412 in the range of 10 degrees to 80 degrees, including all values and ranges therein. Further, the lamination roll 410 is slidable linearly along the second axis 126 by mounting the lamination roller onto a linear guide 414. FIG. 11A illustrates the lamination roll 410 in a first position, under the dispending end 360 of the dispensing head 304, proximal to the transfer film 110 and the idle roll 152. FIG. 11B illustrates the lamination roll 410 in a second position, distal from the transfer film 110 and the idle roll 154. It should be appreciated that either lamination roll 410 may be moved back and forth between the first position and the second position. The linear guide 414 may be moved back and forth by using a linear actuator such as a pneumatic actuator, a hydraulic actuator, or a mechanical actuator such as a belt driven, gear driven, or screw driven actuator, driven by a motor 415.

The amount and thickness of the polymer precursor dispensed on the transfer film 110, in embodiments, is controlled by the speed of the lamination roll 410, the speed of the transfer film 110 passing by the lamination roll 410, and the distance 416 (see FIG. 11B) between the transfer film 110 and the lamination roll 410. Similar to temperature and pressure, these parameters, angular speed of the lamination roll, linear velocity of the transfer film, the distance between the transfer film 110 and the lamination roll 410 may also affect the dynamic viscosity and flow behavior of the polymer precursor, exerting shear on the polymer precursor. The lamination roll 410, in embodiments, includes coatings, surface finishes, engravings, texture or other modifications to facilitate transfer of the polymer precursor from the lamination roll 410 onto the transfer film 110. The coatings may provide abrasion resistance and desirable surface energy characteristics, depending on the polymer precursor used, to provide homogeneous transfer of the polymer precursor from the lamination roll 410 to the transfer film 110. Other factors affecting transfer of the polymer material onto the film include the angle 412 formed between the dispensing head 304 and the lamination roll 410, the positioning of the lamination roll 410 relative to the idle roll 152 relative to the first axis 124 and the second axis 126, and the ratio between the diameter of the lamination roll 410 and the idle roll 152. In addition, the thickness of the transfer film 110, the material the transfer film 110 is formed from, coatings on the transfer film, and the surface texture of the transfer film 110 will alter the transfer characteristics of the polymer precursor from the lamination roll 410.

In embodiments, as the polymer precursor is delivered to the lamination roll 410, the lamination roll 410 spins at the same tangential velocity direction as the movement of the transfer film 110. Further, in embodiments, shear may be induced in the polymer precursor by moving the transfer film 110 at a velocity higher, in the range of 2 times to 20 times, including all values and ranges therein such as 10 times, the speed of the lamination roll 410. This may assist in minimizing grooves and other defects in the polymer precursor.

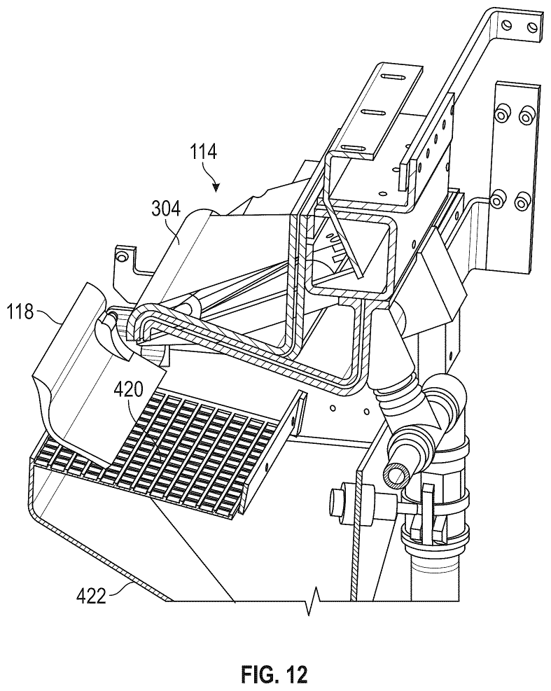

After the portion of the polymer precursor in layer 130 is partially cured to the previously deposited layer 142n+1 (see FIG. 2) and removed from the transfer film 110 by withdrawing the print bed 104 from the transfer film 110, the remaining polymer precursor from layer 130 is removed by use of squeegees 118 as illustrated in FIGS. 11 and 12. The transfer film 110 is forced against the squeegee 118 by the pusher system 220, 222 and pusher bar 232. The excess polymer precursor flows from the squeegee 118 through a filter 420 and into a catch basin 422. As illustrated, the filter 420 is mounted in the catch basin 422. The filter 420 removes any clumps of polymer precursor that may be solidified and the remaining polymer precursor, as illustrated in FIG. 5, is gravity through the second fluid passageway 312 back into the drum 302. Alternatively, the second fluid passageway 312 is connected to another container to be reused later. Additional filters 423 may be provided in the second fluid passageway 312 to remove any further clumps or debris from the polymer precursor being returned to the drum 302. The additional filters 423 may provide elements that induce shear in the polymer precursor as it flows back to the drum 302. In addition, additional mixing elements 435 may be included in the second fluid passageway 312 to induce shear in the polymer precursor as it flows back into the drum 302.

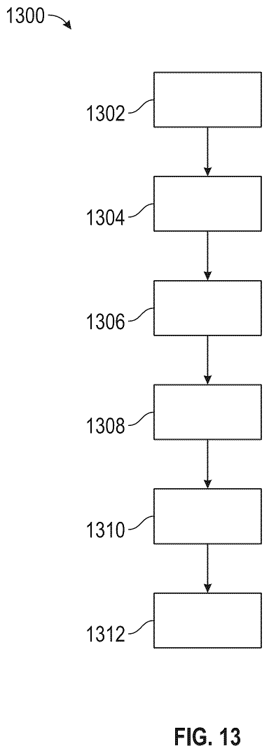

FIG. 13 with further reference to FIGS. 1 through 12, illustrates a general method 1300 of forming a part using the additive manufacturing machine 100. At block 1302 a polymer precursor is deposited onto a transfer film 110. The polymer precursor is dispensed from a dispensing head 304 onto a lamination roll 410 moving at a first angular speed, wherein the dispending head 304 is spaced a distance 418 from the lamination roll 410 to provide or maintain a desired amount of shear imparted to the polymer precursor. The polymer precursor is then transferred from the lamination roll 410 to the transfer film 110 while moving the transfer film at a first linear velocity. The transfer film 110 is moved towards the light engine 116 as the polymer precursor is being transferred onto the transfer film 110 to form a layer 130 of the polymer precursor on the transfer film 110. At block 1304, the print bed 104 and support surface 106 are raised towards the light engine 116 and the support surface, or a previously printed layer 142n+1, contact the polymer precursor layer 130 on the transfer film 110. At block 1306 the light engine activates a light source 132 within the light engine 116. The light source 132 casts light in a desired pattern onto the polymer precursor layer 130 to at least partially cure the polymer precursor layer 130 and, if a previously printed layer 142n+1 is present bind desired portions of the layer being cured to the previously printed layer 142n+1. At block 1308, the at least partially cured polymer precursor is transferred to the support surface 106 or the previously printed layer 142n+1 as the print bed 104 is lowered. At block 1310, if the at least partially cured polymer precursor has not been fully cured, the at least partially cured polymer precursor is cured when the next layer is printed or cured in a post printing process by applying light to the component. Optionally, at block 1312, a cleaning device may be used to remove uncured polymer precursor from the last deposited layer, now 142n+1, of the component 144.

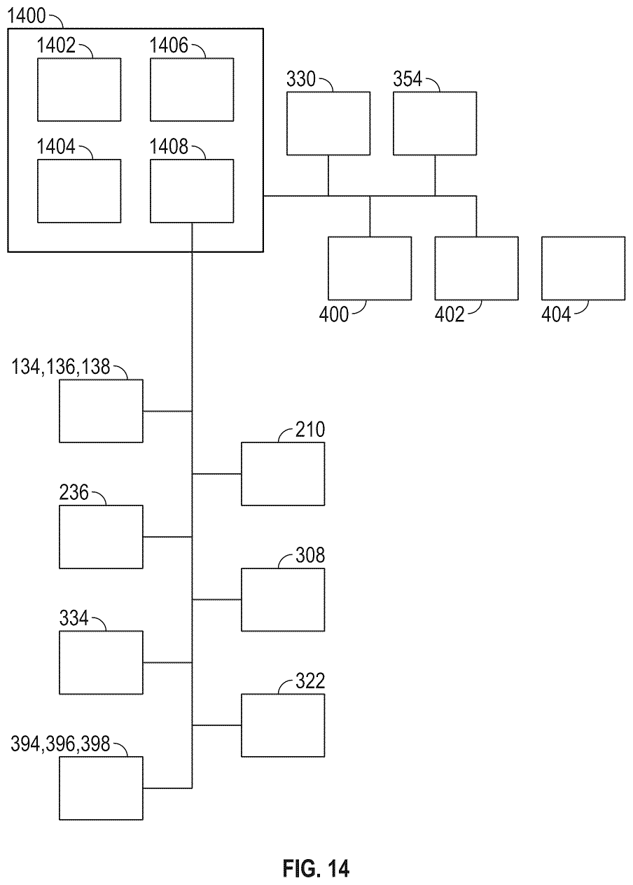

Throughout this method 1300, the process is monitored by a control system, an embodiment of which is illustrated in FIG. 14. The control system 1400 includes one or more controllers 1400, which includes one or more processors 1402 for executing algorithms and other processes embodied by code stored in at least one of the processor 1402 and tangible, non-transitory memory 1404. In executing such algorithms and processes, the processors 1402 may access data from a number of sensors, including the temperature sensor 330 in the drum 302, pressure sensors 354, and temperature sensors 400, 402, 404 in the dispensing head 304. The data is, in embodiments, stored in the tangible, non-transitory memory 1404. In addition, in executing such algorithms and processes the processors 1402 may drive the motors, such as the motors used to drive the linear actuators 134, 136, 138, motor 210 to drive the transfer film 110, the motor 236 to drive the eccentric roller 230, pump 308, agitation element 323 (agitation motor 334), and lamination roll 410 as well as the heating elements including the heating element 322 operatively coupled to the drum 302 and the heating elements 394, 396, 398 in the dispensing head 304. The controller may also include an input and output devices 1408 configured to receive inputs from the various sensors as well as user inputs and configured to provide outputs to the various motor, fans, light engine, and temperature devices that are present in the machine as well as to provide information to a user regarding system status.

Based on the inputs from the various sensors, the controller 1400 may make determinations to turn on and off the pump 308. For example, the controller 1400 turns the pump 308 on when a layer 130 is being deposited on the transfer film 110 and turns the pump 308 off when the transfer film 110 is located under the light engine 116. Further, when two or more pumps 308 are present, the controller 1400 selects which pump 308 to turn on based on which polymer precursor is to be printed. The controller 1400 further activates the agitation motor 334 and agitation element 332 at various intervals, when the heating element 322 in the drum 302 is turned on, or when the pump 308 is being activated. Based on information received from the various temperature sensors 330, 400, 402, 404, the heating elements 322, 394, 396, 398 may be activated to maintain desired temperatures. Further, when polymer precursor is being dispensed from the dispensing head 304, the lamination roll 410 motor 411 is activated to rotate the lamination roll 410 at a desired first angular speed and the motor driving the transfer film 110 are adjusted to impart a desired amount of sheer on the polymer precursor.

As used herein, the term “controller” and related terms such as microcontroller, control module, module, control, control unit, processor and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). The controller 1400 may also consist of multiple controllers which are in electrical communication with each other. The controller 1400 may be inter-connected with additional systems and/or controllers of the additive manufacturing machine 100, allowing the controller 1400 to access data such as, for example, speed, acceleration, temperatures, pressures, and various other process characteristics of the additive manufacturing machine 100.

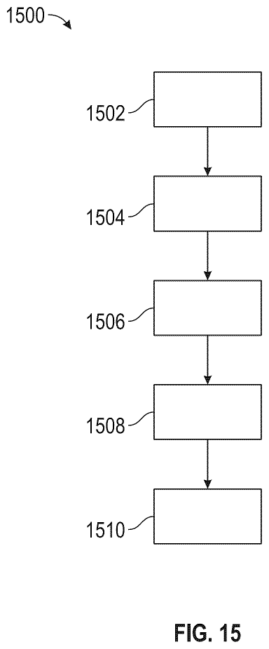

Further, the controller 1400 may be used to calibrate the distance 416 of the lamination roll 410 relative to the idle rollers 152, 154. FIG. 15 illustrates a method 1500 of calibrating the lamination roll 410. At block 1502 the distance 416 of the lamination roll 410 is altered and moved towards the corresponding idle roller 152, 154 using the motor 415. At block 1504, the control system 1400 determines that the lamination roll 410 has encountered an obstacle (i.e., the idle roll 152, 154), such as when the motor 415 runs but an encoder associated with the motor 415 does not register movement. As the motor 415 runs, an encoder error may be increased at block 1506. At block 1508, it is determined that the encoder error surpasses a predetermined threshold. At block 1510, the controller defines the position the encoder and lamination roll 410 as zero. In embodiments, the process may be repeated a number of times at increasing resolution.

A processor 1402 may be a custom made or commercially available processor, a central processing unit (CPU), a graphics processing unit (GPU), an auxiliary processor among several processors associated with the controller 1400, a semi composite conductor-based microprocessor (in the form of a microchip or chip set), a macroprocessor, a combination thereof, or generally a device for executing instructions.

The tangible, non-transitory memory 1404 may include volatile and nonvolatile storage in read-only memory (ROM), random-access memory (RAM), and keep-alive memory (KAM), for example. KAM is a persistent or non-volatile memory that may be used to store various operating variables while the processor is powered down. The tangible, non-transitory memory 1404 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 1400 to control various systems of the additive manufacturing machine 100.

The communication device 1406 includes one or more interface circuits. In some examples, the interface circuits include wired or wireless interfaces that are connected to a local area network (LAN), the Internet, a wide area network (WAN), wireless local area networks (WLAN), cellular networks, or combinations thereof.

The machines and methods herein offer a number of advantages. These advantages include, for example, the ability to control and dynamically adjust film tension, the inclination of the film to a certain angle from the reference printing surface, and the inclination of the build platform to a certain angle from the reference printing surface, allowing for control of the peeling propagation and peeling of a printed layer from the transfer film. These advantages further include the ability to compensate for creep and film distortion. These advantages further include the ability to reduce air trapping and void formation during the printing process. These advantages additionally include the ability to improve reliability. These advantages also include improving yield. Further, each film and material exhibit different physicochemical interactions that define the peeling force per unit of area to release a cured layer of material from the transfer film and each print job has a different cross-sectional geometry and surface. As a result, peeling forces widely vary from print job to print job. Thus, a further advantage of the machine and methods of the present disclosure is the ability to implement strategies to control and keep within desired ranges the tension on the film and localization of peeling forces in order to avoid an accelerated film degradation and improve part accuracy.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An additive manufacturing machine, comprising:
a drum defining a chamber;
a pump including a pump inlet and a pump outlet, wherein the pump inlet is connected to the chamber;
a first fluid passageway connected to the pump outlet;
a dispensing head including a dispensing end and a reservoir end, the reservoir end connected to the first fluid passageway;
a transfer film configured to move relative to the dispensing head; and
a rotatable lamination roll mounted movably slidable relative to the transfer film between a first position and a second position, wherein when in the first position, the rotatable lamination roll is positioned under the dispensing end of the dispensing head.

2. The additive manufacturing machine of claim 1, wherein the drum includes an agitation element inserted in the chamber.

3. The additive manufacturing machine of claim 2, wherein the agitation element includes one or more of the following: a mechanical agitator, an ultrasonic transducer, a magnetic stirrer, a pneumatic shaker, a pneumatic pump, a hydraulic shaker, a hydraulic pump, a shear plate, and a rotary tumbler.

4. The additive manufacturing machine of claim 2, wherein the drum includes a heating element inserted in the chamber.

5. The additive manufacturing machine of claim 3, wherein the drum further includes a temperature sensor inserted in the chamber.

6. The additive manufacturing machine of claim 5, further comprising a controller configured to execute code to control a temperature of a polymer precursor in the chamber based on one or more of the following: 1) a temperature measured by the temperature sensor, and 2) a viscosity measured by a power applied to the agitation element to maintain a given output velocity.

7. The additive manufacturing machine of claim 1, further comprising a pressure sensor operatively coupled to the first fluid passageway.

8. The additive manufacturing machine of claim 1, wherein the pump includes at least one of a positive displacement pump, a piston pump, and a screw pump.

9. The additive manufacturing machine of claim 1, wherein the dispensing head includes a first plate, a second plate defining a reservoir, and a shim positioned between the first plate and second plate, wherein the shim defines a cavity between the first plate and the second plate and the shim seals the cavity, and the first plate, the second plate and the shim define the dispensing end.

10. The additive manufacturing machine of claim 1, wherein the dispensing head includes a temperature sensor.

11. The additive manufacturing machine of claim 10, wherein the dispensing head includes a heating element.

12. The additive manufacturing machine of claim 1, further comprising a build platform, the transfer film movably mounted on the build platform, the transfer film defining an external surface and an internal surface, and an idle roller rotatably mounted to the build platform and rotatably contacting the internal surface of the transfer film.

13. An additive manufacturing machine, comprising:
a build platform;
a transfer film movably mounted on the build platform, the transfer film defining an external surface and an internal surface;
a first bracket and a second bracket mounted to the build platform;
a squeegee mounted to the first bracket and second bracket proximal to the external surface of the transfer film; and
a pusher bar movably mounted to the first bracket and the second bracket, wherein in a first position the pusher bar does not contact the transfer film and in a second position the pusher bar slidably contacting the internal surface of the transfer film and pushes the transfer film against the squeegee.

14. The additive manufacturing machine of claim 13, further comprising an eccentric roller mounted to the first bracket and the second bracket, wherein the eccentric roller contacts the pusher bar and rotation of the eccentric roller moves the pusher bar into the second position.

15. The additive manufacturing machine of claim 13, further comprising a spring biasing the pusher bar in the first position.

16. The additive manufacturing machine of claim 13, further comprising a catch basin mounted to the build platform under the squeegee; and a fluid passageway connecting the catch basin to a drum.

17. The additive manufacturing machine of claim 16, further comprising a filter mounted in the catch basin, wherein the filter is mounted under the squeegee.

18. A method for additive manufacturing comprising:
preconditioning a polymer precursor in a preconditioning system, the preconditioning system including a drum defining a chamber, a heating element inserted in the chamber, a temperature sensor inserted in the chamber, and an agitation element inserted in the chamber;
transferring the polymer precursor from the preconditioning system to a dispensing head;
dispensing the polymer precursor from the dispensing head;
transferring the polymer precursor from the dispensing head onto a transfer film with a lamination roller at a first angular speed;
moving the transfer film at a first linear velocity while transferring the polymer precursor from the dispensing head;
moving the polymer precursor on the transfer film under a light engine;
raising a print bed towards the transfer film;
contacting the polymer precursor with at least one of a support surface and a previously printed layer if present;
emitting light onto the polymer precursor to at least partially cure the polymer precursor;
transferring the at least partially cured polymer precursor onto the at least one of the support surface and the previously printed layer; and
removing an excess polymer precursor from the transfer film.

19. The method of claim 18, wherein removing the excess polymer precursor from the transfer film includes contacting the transfer film with a squeegee by forcing the transfer film against the squeegee with a pusher bar.

20. The method of claim 19, further comprising collecting the excess polymer precursor in a catch basin located under the squeegee; filtering the excess polymer precursor; and
returning the excess polymer precursor to the drum.
